(19) United States
(12) Patent Application Publication
(10) Pub. No.: US 2026/0296089 A1
(43) Pub. Date: Oct. 1, 2026

(54) GLASS FOILER MOUNTING STATION

(71) Applicant: Michael Hacikyan, Naples, FL (US)

(72) Inventor: Michael Hacikyan, Naples, FL (US)

(21) Appl. No.: 19/094,844

(22) Filed: Mar. 29, 2025

(51) Int. Cl. B44C 1/14

(52) U.S. Cl. CPC B44C 1/145

(57) ABSTRACT

A glass foiler mounting station includes a cradle configured to support a glass foiler, a locking mechanism arranged to releasably secure the glass foiler in the cradle, and an adjustable clamp supporting the cradle and configured for removable clamping engagement with a rigid structure.

### BACKGROUND

### 1. Field

The present disclosure relates generally to glass foiling. More particularly, the disclosure concerns a glass foiler mounting station for use by hobbyists in the fabrication of glass artwork and decorative glass products.

### 2. Description of the Prior Art

By way of background, glass foiler apparatus are used to apply a thin strip of metallic foil around the edges of a piece of glass so that it can be soldered to other glass pieces in order to fabricate glass artwork or decorative glass products. The foil strip, which is typically copper, has adhesive on one side for adhering the foil to the glass. During application of the foil strip, the foil is adhered along the glass edge with the strip centered thereon. The sides of the foil strip that overhang the glass edge are folded over and adhered to each side of the glass. The glass may then be soldered to one or more other glass pieces as desired.

It is to improvements in the design and use of glass foiler apparatus and related components that the presently disclosed subject matter is directed.

### SUMMARY

A glass foiler mounting station as disclosed herein includes a cradle configured to support a glass foiler, a locking mechanism arranged to releasably secure the glass foiler in the cradle, and an adjustable clamp supporting the cradle and configured for removable clamping engagement with a rigid structure. A method for using the glass foiler mounting station is also disclosed.

### BRIEF DESCRIPTION OF THE DRAWINGS

FIG. 1 is a front perspective view showing an example embodiment of a glass foiler mounting station that may be constructed in accordance with the present disclosure, in combination with a handheld glass foiler.

FIG. 2 is a rear perspective view of the glass foiler mounting station and handheld glass foiler combination of FIG. 1.

FIG. 3 is an exploded front perspective view showing the glass foiler mounting station and handheld glass foiler combination of FIG. 1.

FIG. 4 is an exploded rear perspective view showing the glass foiler mounting station and handheld glass foiler combination of FIG. 1.

FIG. 5 is an exploded rear perspective view showing the glass foiler mounting station of FIG. 1, including a cradle, an adjustable clamp and a locking mechanism thereof.

FIG. 6 is a top perspective view showing the cradle of FIG. 5.

FIG. 7 is a bottom perspective view of the cradle of FIG. 6.

FIG. 8 is an end elevation view of the cradle of FIG. 6.

FIG. 9 is a side elevation view of the cradle of FIG. 6.

FIG. 10 is a top plan view of the cradle of FIG. 6.

FIG. 11 is a bottom view of the cradle of FIG. 6.

FIG. 12 is a transverse cross-sectional view of the cradle of FIG. 6 taken along line 12 -12 in FIG. 10.

FIG. 13 is a perspective view of the transverse cradle cross-section shown in FIG. 12.

FIG. 14 is a longitudinal cross-sectional view of the cradle of FIG. 6 taken along line 14 -14 in FIG. 10.

FIG. 15 is a perspective view of the longitudinal cradle cross-section shown in FIG. 12.

FIG. 16 is a cross-sectional perspective view taken along line 16 -16 in FIG. 4.

FIG. 17 is a side elevation view of the glass foiler mounting station and handheld glass foiler combination of FIG. 1, with the handheld glass foiler secured in a first orientation.

FIG. 18 is a side elevation view of the glass foiler mounting station and handheld glass foiler combination of FIG. 1, with the handheld glass foiler secured in a second orientation.

FIG. 19 is a side elevation view of the glass foiler mounting station and handheld glass foiler combination of FIG. 1, with the handheld glass foiler secured in a third orientation.

### DETAILED DESCRIPTION OF EXAMPLE EMBODIMENTS

Turning now to the drawing figures, which are not necessarily to scale, like reference numbers are used to represent like elements in all of the several views.

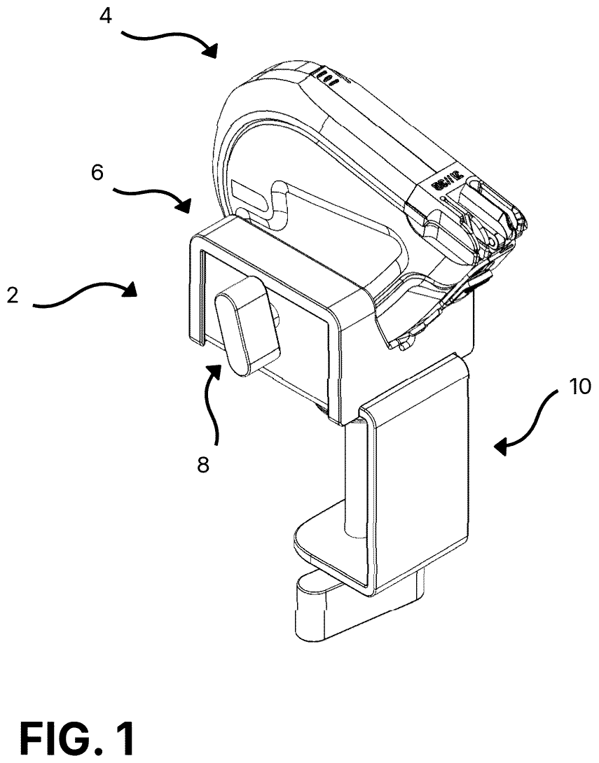

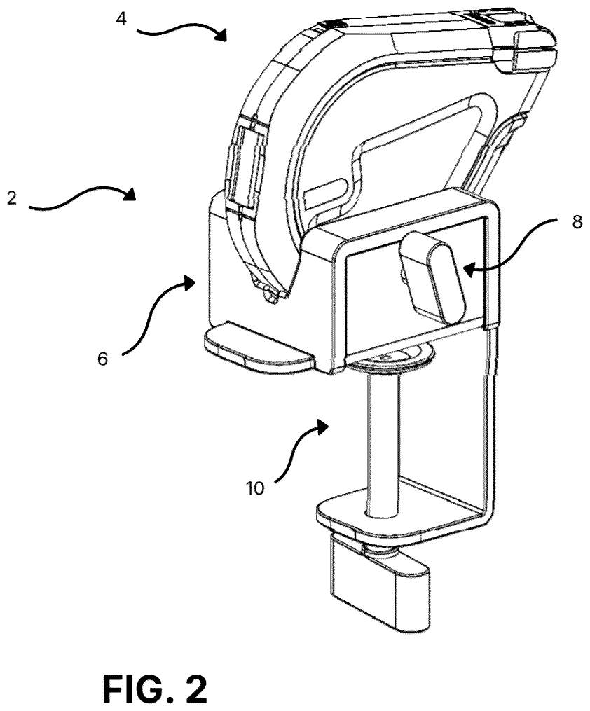

FIGS. 1-2 illustrate a glass foiler mounting station 2 that may be constructed in accordance an example embodiment of the present disclosure, with the mounting station securely mounting a glass foiler 4 that is to be used in a glass foiling operation. In the illustrated embodiment, the mounting station 2 includes a cradle 6 configured to support the glass foiler 4, a locking mechanism 8 arranged to releasably secure the glass foiler 4 in the cradle, and an adjustable clamp 10 supporting the cradle and configured for removable clamping engagement with a rigid structure (not shown), such as the edge of a table top. As described in more detail below, the cradle 6 is configured to support the glass foiler 4 in more than one orientation and the locking mechanism 8 is arranged to releasably secure the glass foiler in the more than one orientation.

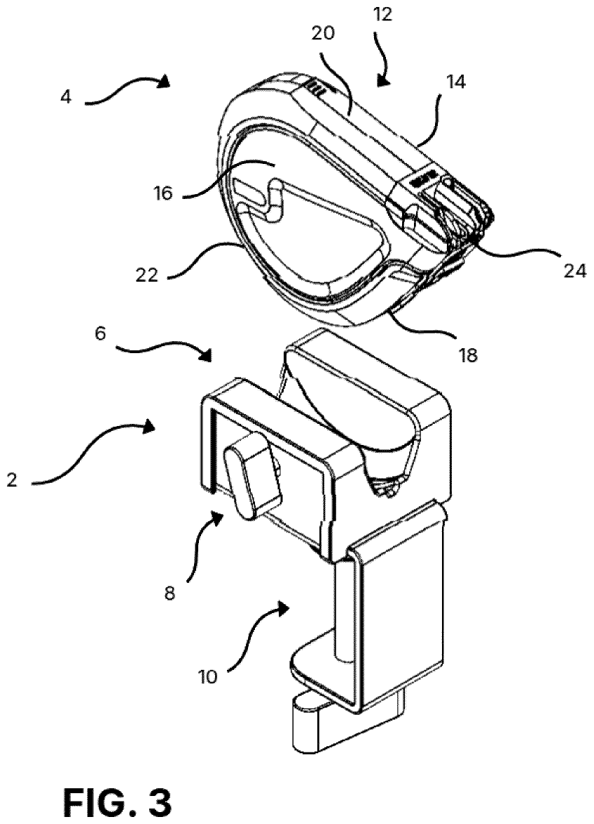

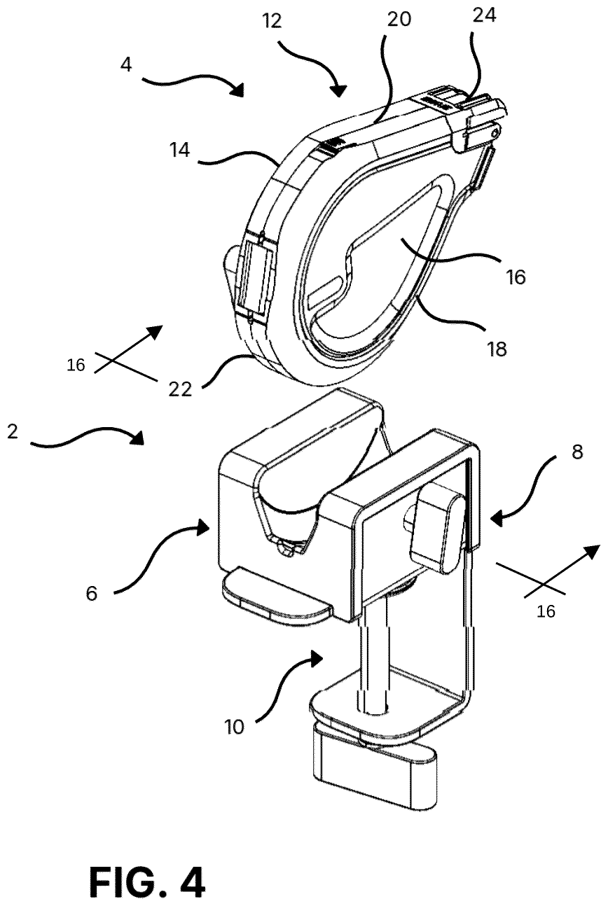

The glass foiler 4 depicted in FIGS. 1-2 is a compact handheld foiler designed for handheld use. As additionally shown in FIGS. 3-4, the glass foiler 4 (which is inverted in the drawing figures) includes a foiler housing 12 formed with two major sidewalls 14 and 16, a thumb-receiving edge portion 18 arranged to engage a thumb of the human hand, a finger-receiving edge portion 20 arranged to engage the remaining fingers of the human hand, a thenar-engaging edge portion 22 arranged to engage a thenar region of the human hand, and a foil-dispensing tip portion 24 opposite the thenar-engaging portion where the thumb-engaging and finger-engaging edge portions merge. Thus configured, it will be appreciated that the one of the sidewalls 14 and 16 of the glass foiler 4 will engage a user's palm depending on whether the glass foiler is held in the user's right hand or left hand. In particular, a right-handed user will hold the glass foiler 4 so that the sidewall 14 engages their palm whereas a left-handed user will hold the glass foiler so that the sidewall 16 engages their palm.

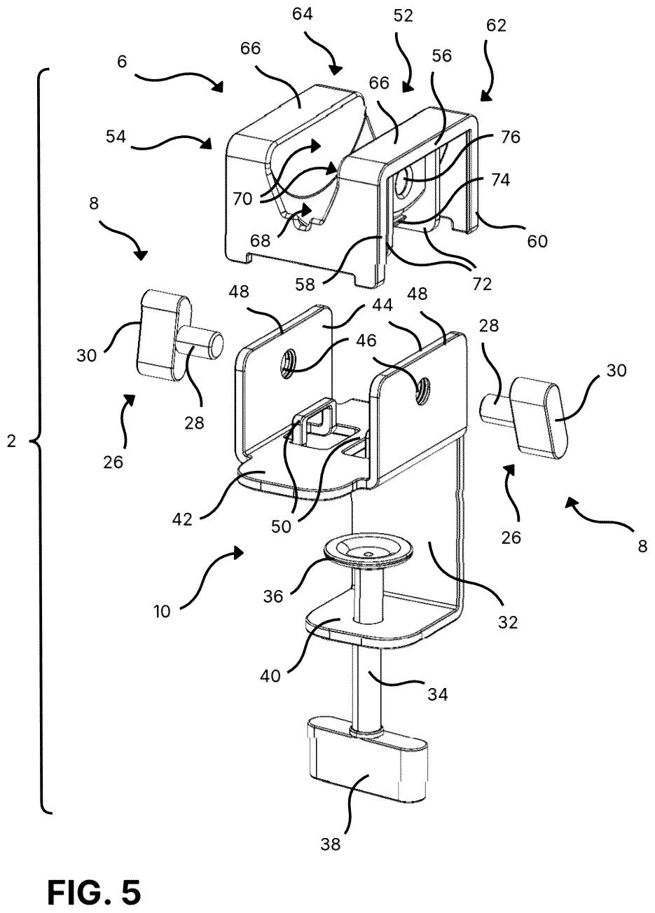

With additional reference to FIG. 5, the cradle 6 may be implemented as a molded structure made primarily of silicone rubber or other comparatively soft and flexible material. Other flexible materials may also be used.

The locking mechanism 8 may include at least one linearly adjustable member. In the illustrated embodiment, the locking mechanism 8 is implemented using a pair of thumbscrews 26 whose threaded shanks 28 are made of metal, rigid plastic or other suitable mechanical fastening material. The thumbscrews 26 have finger-engaging handles 30 that may be formed of the same material as the threaded shank 28 (possibly with a different material coating such as plastic over metal), or they may be formed of an entirely different material.

The adjustable clamp 10 may be formed from metal, plastic or other material that is rigid enough to support the mounting station 2 and the glass foiler 4 in a substantially fixed position during glass foiling operations. The overall configuration of the adjustable clamp 10 may be that of a G-clamp (a.k.a. C-clamp), with many other configurations also being possible. In the illustrated embodiment, the adjustable clamp 10 includes a C-shaped frame 32 and an adjustable clamp screw 34. The clamp screw 34 has a movable workpiece-clamping jaw 36 on its upper end that may, for example, be used to engage the underside of a table top edge. A clamp handle 38 is provided on the lower end of the clamp screw. A lower screw-engaging leg 40 of the clamp frame 32 threadably receives the screw 34. An upper a workpiece-engaging leg 42 of the clamp frame 32 opposes the workpiece clamping jaw 36. The workpiece-engaging leg 42 may, for example, be used to engage the upper side of a table top edge.

The workpiece-engaging leg 42 of the adjustable clamp 10 also includes structure that mounts the cradle 6 and the locking mechanism 8 to the clamp. While such mounting structure may take many forms, the illustrated embodiment makes use of a pair of cradle mounting flanges 44 extending upwardly from the workpiece-engaging leg 42 and substantially perpendicular thereto. It will be appreciated that the cradle mounting flanges 44 may be integrally formed as part of the workpiece-engaging leg 42 (as shown in FIG. 5) or they may be separately-formed structures attached thereto.

Each cradle mounting flange 44 is formed with a threaded hole 46 that receives one of the thumbscrew shanks 28. The cradle mounting flanges 44 may be formed in various configurations, with the illustrated embodiment depicting them as being substantially rectangular so as to define an upwardly convex cradle support edge 48 having an inverted U-shape. The cradle support edges 48 provide spaced-apart support and mounting surfaces for the cradle 6. Disposed between each cradle mounting flange 44, proximate to the base thereof, are a pair of loop connectors 50 that provide attachment points for securing the cradle 6. The loop connectors 50 may be formed in various configurations, with the illustrated embodiment depicting them as inverted U-shaped brackets that are thin and wire-like.

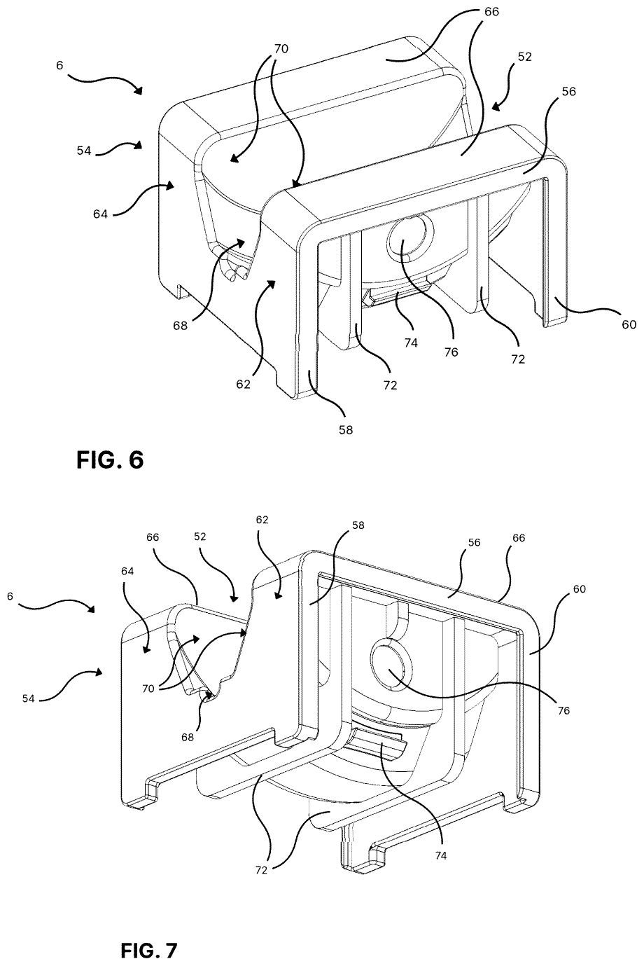

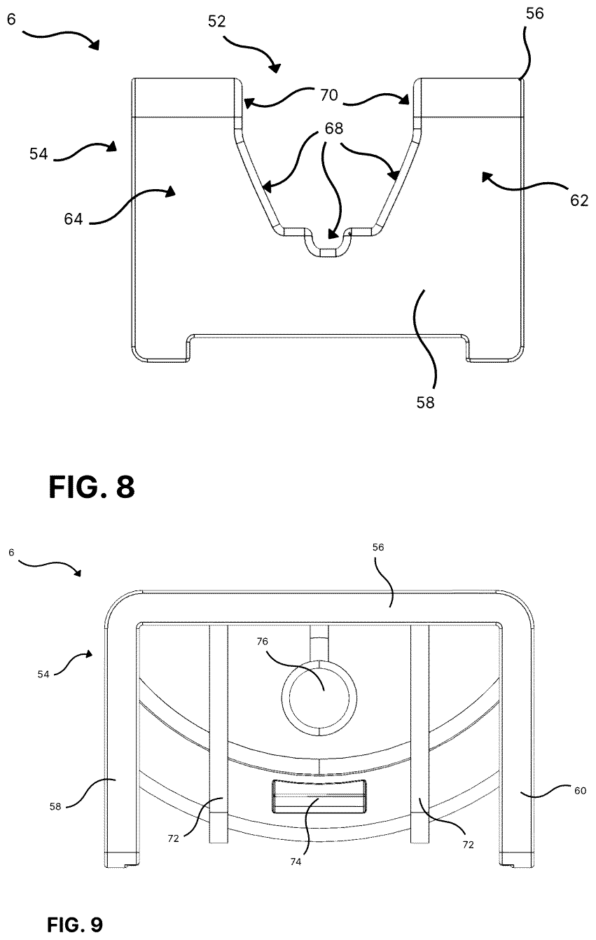

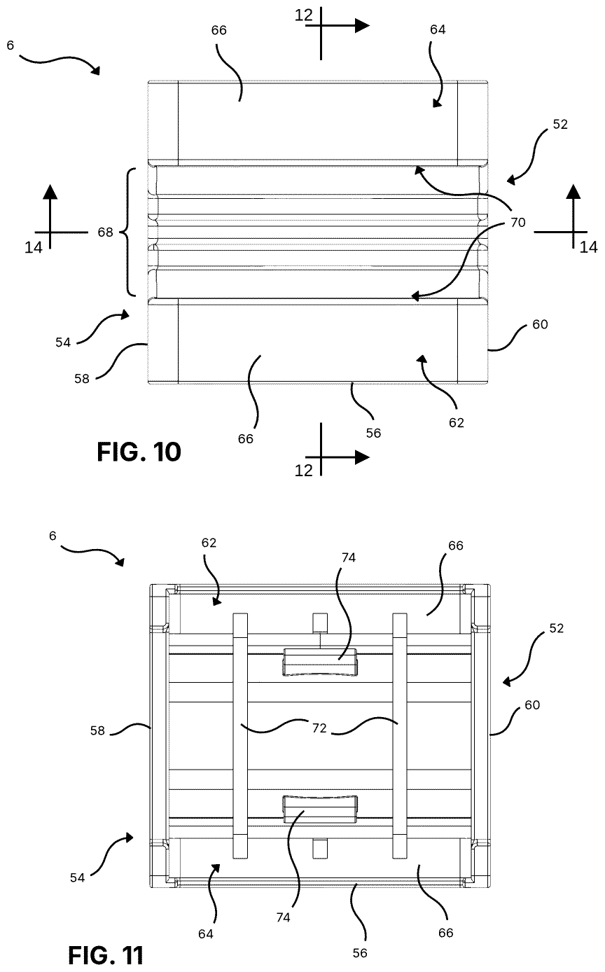

With additional reference to FIGS. 6-8, the cradle 6 is formed with a central foiler-receiving pocket 52 that bisects a cradle frame 54 that may be generally configured as an inverted U-shaped structure. As additionally shown in FIG. 9, the cradle frame 54 includes an upper base member 56 with respective front and rear members 58 and 60 depending downwardly therefrom. As additionally shown in FIG. 10 (top view) and 11 (bottom view), the foiler-receiving pocket 52 passes longitudinally through the front and rear members 58 and 60 to effectively divide the cradle frame 54 into two separately identifiable frame sections 62 and 64 respectively situated on either side of the foiler-receiving pocket. The separate frame sections 62 and 64 define two spaced-apart lateral shoulders 66 of the cradle. As can be seen in FIG. 5, the cradle shoulders 66 are substantially configured as inverted U-shaped structures that are arranged to rest on the cradle support edges 48 of the cradle mounting flanges 44, in wrapping engagement therewith.

The foiler-receiving pocket 52 of the cradle 6 is configured according to the shape of the glass foiler 4, thereby forming a foiler-carrying nest that can fix the glass foiler in a stable position, and support it in more than one orientation.

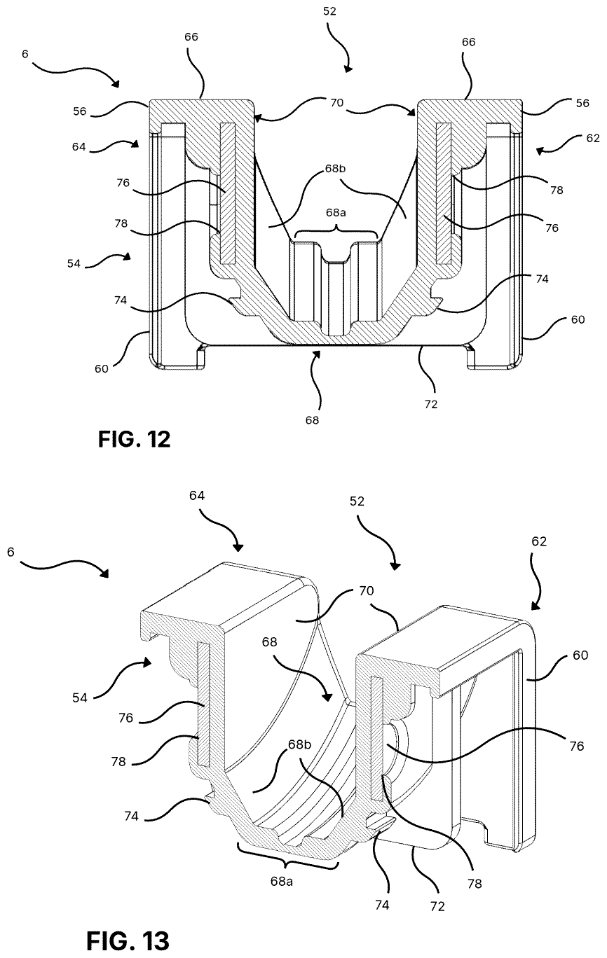

With additional reference to FIGS. 12-15, the cradle 5 accommodates the particular shape of the glass foiler 4 (as previously described in connection with FIGS. 3-4) by virtue of the foiler-receiving pocket 52 being formed with a central longitudinal cradle spine 68 and a pair of cradle sidewalls 70 extending substantially upwardly from each side of the cradle spine. The cradle spine 68 represents a foiler edge-engaging portion of the foiler-receiving pocket 52 that is configured to engage one or more of the glass foiler edge portions. Depending on the orientation of the glass foiler 4 when it is fixed in the cradle 4, the cradle spine 68 may engage some or all of the foiler's thumb-engaging edge portion 18 and/or some or all of the foiler's thenar-engaging edge portion 22. The cradle sidewalls represent a foiler sidewall-engaging portion of the foiler-receiving pocket 52 that is configured to engage the glass foiler major sidewalls. The cradle sidewalls 70 are configured and arranged so that their inside faces respectively oppose the sidewalls 14 and 16 of the glass foiler 4.

FIGS. 12-13 illustrate the transverse profile of the foiler-receiving pocket 52. As can be seen, the cradle spine 68 has a transverse profile configured to match the transverse profile of the glass foiler's thumb-engaging edge portion 18 and thenar-engaging edge portion 22. As best shown in FIGS. 3 and 4, the foiler edge portions 18 and 22 are each transversely profiled with a central flat surface situated between two rounded corners. As such, FIGS. 12 and 13 depict the longitudinal spine 68 of the foiler-receiving pocket 52 being formed with a corresponding flat central spine region 68a and corresponding rounded corner regions 68b. As can also be seen in FIGS. 12 and 13, the cradle sidewalls 70 have a transverse profile configured to match the profile of the glass foiler sidewalls 14 and 16. As best shown in FIGS. 3 and 4, the glass foiler sidewalls 14 and 16 are substantially flat and mutually parallel. As such, FIGS. 12 and 13 depict the cradle sidewalls 70 being formed as substantially flat and mutually parallel surfaces.

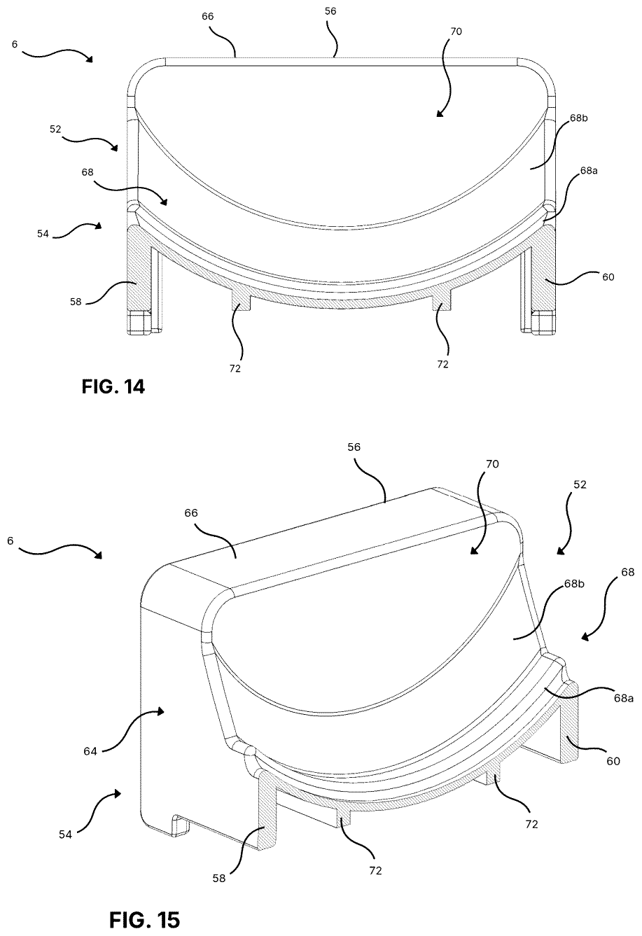

FIGS. 14 and 15 illustrate the longitudinal profile of the foiler-receiving pocket 52. As can be seen, the cradle spine 68 has a longitudinal profile configured to match the longitudinal profile of the foiler's thumb-engaging edge portion 18 and thenar-engaging edge portion 22. As best shown in FIGS. 3 and 4, the foiler edge portions 18 and 22 have a longitudinal profile that is gradually rounded with a relatively large radius of curvature. As such, the longitudinal spine 68 of the foiler-receiving pocket 52 has a matching curvature that is likewise gradually rounded with a relatively large radius of curvature. The longitudinal spine 68 may have a maximum depth (relative to the upper base member frame 56 of the cradle frame 54) at its longitudinal midpoint. With respect to the sidewalls 70 of the foiler-receiving pocket 52, their longitudinal profile is substantially flat like the sidewalls 14 and 16 of the glass foiler 4.

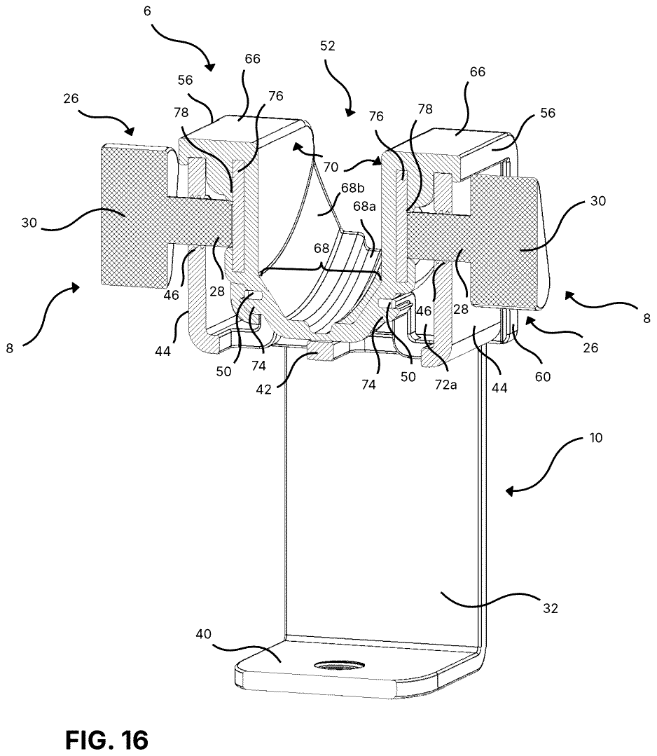

As can be seen in FIGS. 5-7, 9 and 11-15, the cradle 6 may be formed with structural support ribs 72 that wrap around the outside of the foiler-receiving pocket 52 to enhance its structural integrity. As best shown in FIGS. 5-7, 9, 12 and 13, the structural support ribs 72 include side sections that extend laterally outwardly from the foiler-receiving pocket 52. As can be seen with additional reference to FIG. 16, the side sections of the support ribs 72 (shown by reference number 72a in FIG. 16) are arranged to engage the inside surfaces of the cradle mounting flanges 44. This engagement laterally stabilizes the cradle 6 between the cradle mounting flanges 44.

As can be seen in FIGS. 5-7, 9 and 11-12, the cradle 6 may be formed with attachment hook members 74 that are arranged to engage the loop connectors 48 formed on the workpiece-engaging leg 42 of the adjustable clamp 10. FIG. 16 depicts how the cradle hook members 74 fasten to the loop connectors 48.

As can be seen in FIG. 5, the outer surfaces of the foiler-receiving pocket's sidewalls 70 are arranged for facing relationship with the shanks 28 of the locking mechanism thumbscrews 26 when the cradle 6 is mounted to the adjustable clamp 10. As the thumbscrew shanks 28 are advanced through the threaded holes 46 of the cradle mounting flanges 44, the tips thereof will move toward engagement with the cradle sidewalls 70. In order to protect the cradle sidewalls 70 from the potential wear-inducing effects of thumbscrew shank tips, each sidewall may have embedded therein a thumbscrew-engaging member 76 made from metal or other substantially rigid and/or durable wear-resistant material. The thumbscrew-engaging members 76 are designed to withstand the frictional wear caused by repeated rotational engagement with the tips of the thumbscrew shanks 28. For example, the thumbscrew-engaging members 76 may be formed as stainless steel plate elements. As best shown in FIGS. 12, 13 and 16, the thumbscrew-engaging members 76 may be situated in a sidewall pocket 78 formed in each sidewall 70 of the foiler-receiving pocket 52. The sidewall pockets 78 are formed with openings that expose the thumbscrew-engaging members 76 to the thumbscrew shanks 28.

The locking mechanism 8 of the glass foiler mounting station 2 is operable to releasably clamp one or both of the cradle sidewalls 70 against one or both of the glass foiler sidewalls 14 and 16. As shown in FIGS. 5 and 16, the locking mechanism thumbscrews 26, whose thumbscrew shanks 28 are threadably engaged in the threaded holes 46 of the cradle mounting flanges 44, can be advanced independently (or together) toward and away from one or both of the cradle sidewalls 70, in alignment with the thumbscrew-engaging members 76. In the illustrated embodiment, both of the cradle sidewalls 70 are flexible. When it is desired to secure the glass foiler 4 in the cradle 6, one or both of the thumbscrews 26 may be advanced until their thumbscrew shanks 28 contact and flex one or both of the cradle sidewalls 70 inwardly. This will tighten the cradle sidewalls 70 against the glass foiler sidewalls 14 and 16, and thereby secure the glass foiler 4 in the mounting station 2.

In an alternative embodiment (not shown), the mounting station 2 could be implemented so that the locking mechanism 8 has only one thumbscrew 26 that flexes only one of the cradle sidewalls 70. In that case, the opposite sidewall 70 could be constrained or made rigid to prevent it from flexing.

In a further alternative embodiment (not shown), the mounting station 2 could be implemented so that the locking mechanism thumbscrews 26 do not engage and flex either of the cradle sidewalls 70. For example, the cradle sidewalls 70 could be formed with openings that allow one or both of the thumbscrew shanks 28 to pass through and directly engage one or both of the glass foiler sidewalls 14 and 16. In that case, the tips of the thumbscrew shanks 28 could be formed with soft and/or low-friction material that will not damage the glass foiler 4.

In the illustrated embodiment, the cradle 6 and the adjustable clamp 10 are separate components attached together. The cradle 6 is formed of a comparatively flexible material (such as silicone rubber) and the adjustable clamp 10 is formed of a comparatively rigid material, such as plastic. In an alternative embodiment, the mounting station 2 could be modified so that the cradle 6 and the adjustable clamp 10 are not separate components but are instead wholly or partially integrated together. For example, the cradle frame 54 could be integrally formed with the clamp frame 32 using a comparatively rigid material, and the foiler-receiving pocket 52 could be a separate component made of a comparatively flexible material that is mounted to the integrated cradle frame/clamp frame.

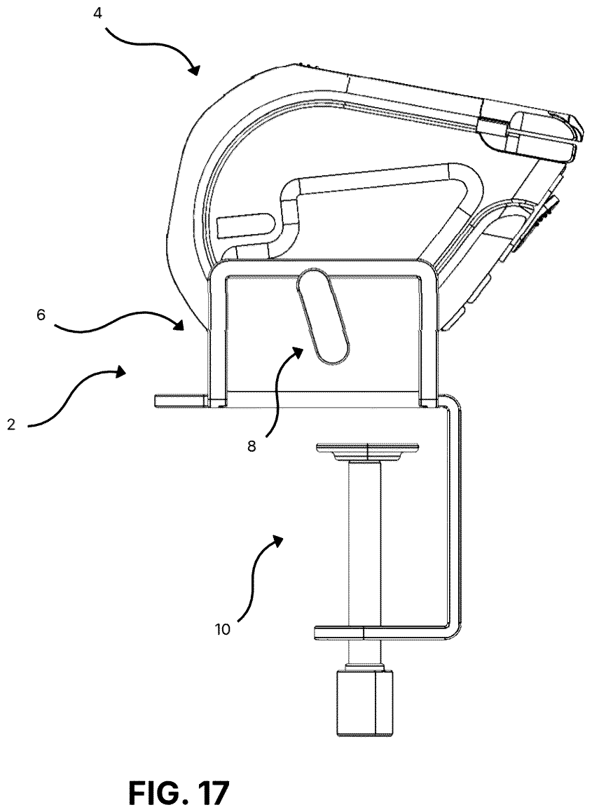

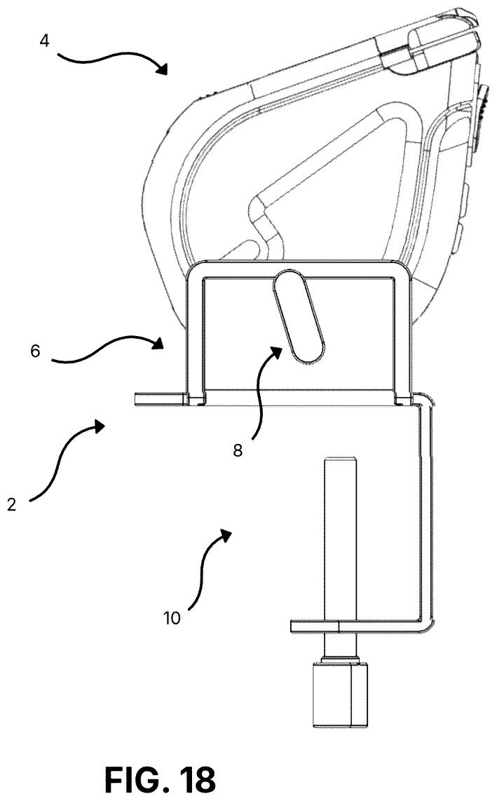

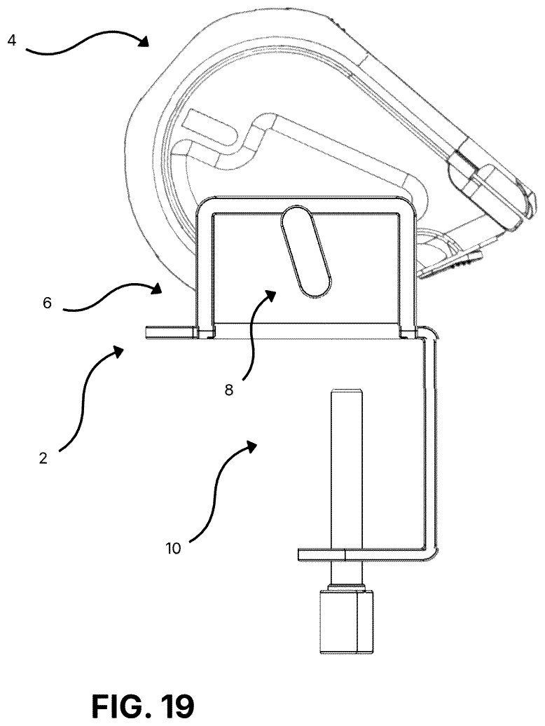

Turning now to FIGS. 17-19, the mounting station 2 is shown in combination with the glass foiler 4 in three different foiler orientations. In each figure, the glass foiler 4 is supported in the cradle 6 in selected operational position, and secured by the locking mechanism 8 for glass foiling operations. As previously noted, the cradle 6 is configured to support the glass foiler 4 in more than one orientation, and the locking mechanism 8 is operable to releasably secure the glass foiler in the more than one orientation. By way of example, FIG. 17 depicts the glass foiler 4 oriented and secured in a first operational position. In FIG. 18, the glass foiler 4 has been pivoted counterclockwise in order to orient and secure it in a second operational position. In FIG. 19, the glass foiler 4 has been pivoted clockwise in order to orient and secure it in a third operational position.

It will be appreciated that the operational positions shown in FIGS. 17-19 are merely representative examples of how the glass foiler 4 may be arranged in the mounting station 2. In practice, the mounting station 2 allows the glass foiler 4 to be adjustably pivoted and secured in any desired orientation, including with the glass foiler inverted from the positions shown in FIGS. 17-19 (with or without reconfiguration of the foiler-receiving pocket 52 for enhanced accommodation of the foiler's finger-receiving edge portion 20).

The mounting station 2 may be setup and used for glass foiling operations very quickly and efficiently. As an initial step, the mounting station 2 may be secured to a suitable rigid structure (such as a table top edge) using the adjustable clamp 10. The glass foiler 4 may then be placed in the cradle 6 at a desired orientation, and the locking mechanism 8 may be activated in order to secure the glass foiler 4 in the cradle. The glass foiler 4 may then be used to apply foil to a glass edge. When the foiling operation has been completed, the locking mechanism 8 may be deactivated to release the glass foiler 4 from the cradle. The glass foiler 4 may then be removed from the cradle 6.

Accordingly, embodiments of a glass foiler mounting station and a related method have been disclosed. Reference in the present disclosure to an “embodiment” means that a particular feature, structure or characteristic described in connection with the embodiment may be included in at least one embodiment of the disclosed device. Thus, the appearances of the term “embodiment” in various places throughout the specification are not necessarily all referring to the same embodiment.

For purposes of explanation, specific configurations and details have been set forth herein in order to provide a thorough understanding of the present disclosure. However, it will be apparent to one of ordinary skill in the art that embodiments of the disclosed subject matter may be practiced without the specific details presented herein. Furthermore, well-known features may have been omitted or simplified in order not to obscure the present disclosure. Various examples have been given throughout this description. These examples are merely descriptions of specific embodiments of the disclosed subject matter. The scope of the claimed subject matter is not limited to the examples given.

As used herein, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure dispenser e, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

All of the drawing figures and examples herein are intended to be non-limiting. They merely represent examples of how the inventive subject matter recited in the claims appended hereto may be implemented in practice. Modifications to the configuration and arrangement of components, assemblies and operations of the apparatus and methodologies disclosed herein may be implemented without departing from the spirit and scope of the disclosed subject matter. Thus, although example embodiments have been shown and described, it should be apparent that many variations and alternate embodiments could be implemented in accordance with the present disclosure. It is understood, therefore, that the scope of the disclosed subject matter is not to be limited except in accordance with the appended claims and equivalents thereof.

What is claimed is:

1. A glass foiler mounting station, comprising:
a cradle configured to support a glass foiler;
a locking mechanism arranged to releasably secure the glass foiler in the cradle; and
an adjustable clamp supporting the cradle and configured for removable clamping engagement with a rigid structure.

2. The glass foiler mounting station of claim 1, wherein the cradle is configured to support the glass foiler in more than one orientation and the locking mechanism is arranged to releasably secure the glass foiler in the more than orientation.

3. The glass foiler mounting station of claim 1, wherein the cradle comprises a central longitudinal spine and a pair of cradle sidewalls extending from each side of the central longitudinal spine.

4. The glass foiler mounting station of claim 3, wherein the cradle spine is configured to engage an edge portion of the glass foiler, and wherein the cradle sidewalls are configured to engage sidewalls of the glass foiler.

5. The glass foiler mounting station of claim 4, wherein the locking mechanism is arranged to releasably clamp one or both of the cradle sidewalls against one or both of the glass foiler sidewalls.

6. The glass foiler mounting station of claim 4, wherein the one or both cradle sidewalls are flexible and the locking mechanism flexes the one or both cradle sidewalls inwardly toward the one or both glass foiler sidewalls.

7. The glass foiler mounting station of claim 4, wherein the locking mechanism comprises at least one linearly adjustable member arranged to advance toward and away from the one or both cradle sidewalls.

8. The glass foiler mounting station of claim 7, wherein at least one linearly adjustable member comprises at least one thumb screw.

9. The glass foiler mounting station of claim 8, wherein the at least one thumb screw threads through a threaded hole formed in a cradle supporting portion of the clamp.

10. The glass foiler mounting station of claim 8, wherein the one or both cradle sidewalls comprise a substantially rigid thumbscrew-engaging member arranged for contacting engagement with a tip of the at least one thumb screw.

11. The glass foiler mounting station of claim 1, wherein the clamp and the cradle are separate components attached together.

12. The glass foiler mounting station of claim 11, wherein the clamp comprises a comparatively rigid material and the cradle comprises a comparatively flexible material.

13. The glass foiler mounting station of claim 12, wherein the clamp comprises rigid plastic and the cradle comprises silicone rubber.

14. The glass foiler mounting station of claim 10, wherein the thumbscrew-engaging member of the at least one cradle sidewall comprises metal.

15. The glass foiler mounting station of claim 1, wherein the adjustable clamp comprises a G-clamp assembly configured for removable clamping engagement with a table top in a manner that positions the cradle and the glass foiler supported thereon above the table top.

16. A glass foiler mounting station, comprising:
a cradle configured to support a glass foiler sized to be held by a human hand;
the glass foiler comprising a housing formed with two major sidewalls, a thumb-receiving edge portion arranged to engage a thumb of the human hand, a finger-receiving edge portion arranged to engage the remaining fingers of the human hand, a thenar-engaging portion arranged to engage a thenar region of the human hand, and a foil-dispensing portion opposite the thenar-engaging portion;
the cradle comprising a foiler edge-engaging portion configured to engage one or more of the glass foiler edge portions and a foiler sidewall-engaging portion configured to engage the glass foiler major sidewalls;
a locking mechanism arranged to releasably secure the glass foiler in the cradle by way of the cradle's foiler sidewall-engaging portion; and
an adjustable clamp supporting the cradle and configured for removable clamping engagement with a rigid structure.

17. The glass foiler mounting station of claim 16, wherein the one or more glass foiler edge portions are curved, and wherein the cradle's foiler edge-engaging portion has a matching curvature that allows the glass foiler to be pivoted in the cradle in order to adjust an orientation and position of the glass foiler's foil-dispensing portion.

18. The glass foiler mounting station of claim 17, wherein the cradle's foiler edge engaging portion comprises a central longitudinal cradle spine that is curved to accommodate the curvature of the one or more foiler edge portions, and wherein the cradle's foiler sidewall-engaging portion comprises a pair of cradle sidewalls extending from each side of the central longitudinal cradle spine.

19. The glass foiler mounting station of claim 16 in combination with the glass foiler.

20. A method for using the handheld glass foiler mounting station of claim 1, comprising:
securing the glass foiler mounting station to the rigid structure using the adjustable clamp;
placing the glass foiler in the cradle at a desired orientation;
activating the locking mechanism to secure the glass foiler in the cradle in the desired orientation;
using the glass foiler to apply foil to a glass edge;
deactivating the locking mechanism to release the glass foiler from the cradle; and
removing the glass foiler from the cradle.
